(19) United States
(12) Patent Application Publication
(10) Pub. No.: US 2013/0040117 A1
(43) Pub. Date: Feb. 14, 2013

(54) WALL REINFORCED COMPOSITE MATERIAL

(71) Applicants: Alain PORTE, Colomiers (FR); Jacques LALANE, Saint Orens De Gameville (FR)

(72) Inventors: Alain PORTE, Colomiers (FR); Jacques LALANE, Saint Orens De Gameville (FR)

(73) Assignee: AIRBUS OPERATIONS (SAS), Toulouse (FR)

(21) Appl. No.: 13/565,996

(22) Filed: Aug. 3, 2012

(30) Foreign Application Priority Data
Aug. 4, 2011 (FR) 1157150

(51) Int. Cl. B32B 3/10

(52) U.S. Cl. 428/201

(57) ABSTRACT

A wall panel of composite material including at least two carbon fiber layers oriented parallel to the plane of the panel and embedded in a resin matrix. At least one reinforcement mesh is inserted between the two fiber layers. The mesh has at least a first series of linear elements with a section greater than or equal to 0.07 mm² The reinforcement mesh is embedded in the resin matrix, and the two layers arranged on both sides of the mesh are linked in all zones situated between the linear elements of the mesh.

### BACKGROUND OF THE INVENTION

This application claims priority to French Patent Application No. 1157150 filed Aug. 4, 2011, the entire contents of which are hereby incorporated by reference.

1. Field of the Invention

The present invention relates to a wall of reinforced composite material and more particularly to an acoustically treated panel in reinforced composite material.

2. Discussion of Prior Art

To limit the impact of aircraft noise, techniques have been developed for reducing the noise, specifically by installing, in certain walls, panels or coatings to absorb a portion of the sound energy, specifically by using Helmholtz resonators.

This type of panel comprises from the exterior towards the interior a porous soundproofing layer, at least one honeycomb structure and a reflecting or impermeable wall. Alternatively, the panel can comprise several superposed honeycomb structures separated by porous soundproofing layers. The cells of the honeycomb structure(s) are dimensioned to ensure optimized soundproofing. It is understood that layer means one or more layers of the same material which may or may not be similar.

According to one embodiment, the honeycomb structure is in the form of a honeycomb in composite material. The reflecting wall can be of composite material and formed by draping fibers embedded in a resin matrix.

The soundproofing structure is a porous structure for dissipating acoustic energy, partially transforming the energy of the sound wave passing through it into heat. It comprises so-called open zones susceptible of letting the acoustical waves pass through and other zones called closed or full, which do not allow the sound waves to pass through but are intended to ensure the strength of the layer. This soundproofing layer is characterized in particular by a varying level of an open surface depending upon the motor and the components constituting said layer. In general, the soundproofing structure comprises at least one porous layer and at least one reinforcement structure. The porous layer makes the soundproofing linear and traps the acoustic waves in the Helmholtz cells formed by the honeycomb structure.

According to one embodiment, the porous layer is a metallic fabric, specifically a mesh of metallic wires with a diameter of 0.1 mm. According to one advantage, this metallic fabric is an excellent conductor of lightning.

According to one embodiment, when in contact with air flow, this metallic mesh must not generate significant vortices so that the wire diameter is limited to and smaller than 0.1 mm or 0.2 mm. Larger than this, the mesh wires themselves would generate non permissible turbulence from aerodynamic point of view.

The reinforcement structure is in the form of a plate of composite or metallic material in which holes of more or less large section are made. According to one embodiment, the reinforcement structure is in the form of sheet metal with oblong or round perforations.

According to prior art, the porous layer and the reinforcement structure are made independently of each other and are simply connected by gluing so that they adhere to each other.

The acoustical performance of soundproofing panels is constantly improving. They are extremely resistant to certain stresses such as for instance compression stresses in transversal direction (direction perpendicular to the layers) and tension stresses in longitudinal direction (direction contained within the plane of the layers). However, these panels have difficulties withstanding bending stresses. According to another disadvantage, they are not resilient and can break under impact.

In normal use conditions, soundproofing panels perform satisfactorily. However, in case of an incident, whereby the structure of the aircraft to which the acoustic panel is attached has a tendency to deform, the stresses inflicted on the panel can provoke the occurrence of cracks, and the propagation of these cracks can cause the panel to break up in many pieces. In this situation, the acoustic treatment becomes a secondary consideration, it is however important that the damage to the structure of the aircraft is as little as possible so that the aircraft can reach its destination or the nearest landing strip.

### SUMMARY OF THE INVENTION

The goal of the present invention is to mitigate the disadvantages of the prior art by proposing a wall made of composite material with reinforced mechanical properties.

For this purpose, the object of the invention is a wall of composite material comprising at least two carbon fiber layers oriented parallel to the plane of the panel and embedded in a resin matrix, characterized in that it comprises at least one reinforcement mesh inserted between the two fiber layers and comprising at least one first series of linear elements with a section greater than or equal to 0.07 mm², whereby said reinforcement mesh is embedded in the resin matrix, and the two layers arranged on each side are linked in all the zones located between the linear elements.

According to the invention, the carbon fiber layers represent the main force path while the reinforcement mesh improves the mechanical characteristics and confers higher bending strength to the wall obtained in this manner.

### BRIEF DESCRIPTION OF THE DRAWINGS

Other characteristics and advantages of the invention will become clear from the following description of the invention, which is provided only as an example with respect to the attached drawings in which:

FIG. 1 is a cross section of part of a panel according to one embodiment of the invention;

FIG. 2 is a view in perspective of part of a reinforcement mesh according to a first embodiment of the invention;

FIG. 3 is a view in perspective of part of a reinforcement mesh according to another embodiment of the invention;

FIG. 4 is a top view in perspective with partial cutaway views of the different layers of a wall in composite material according to an embodiment of the invention comprising a reinforcement mesh;

FIG. 5 is a top view in perspective with partial cutaway views of the different layers of a wall in composite material according to another embodiment comprising several reinforcement meshes;

FIG. 6 is a cross section of one embodiment of a composite material wall according to the invention;

FIG. 7 is a cross section of another embodiment of a composite material wall according to the invention; and

FIG. 8 is a cross section of another embodiment of a composite material wall according to the invention.

### DETAILED DISCUSSION OF EMBODIMENTS

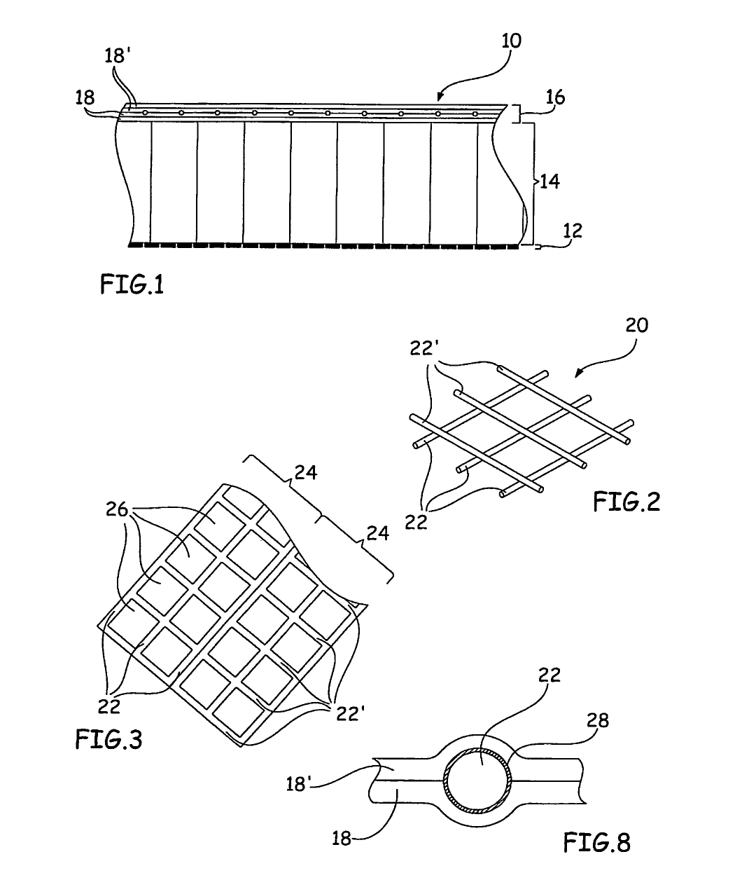

FIG. 1 shows a panel 10 for acoustical treatment comprising from the outside towards the inside a porous sound proofing layer 12, at least one honeycomb structure 14 and an impermeable reflective wall 16. The sound proofing layer 12 and the honeycomb structure 14 are not described because they are known to a person skilled in the art and the sound proofing panels according to the invention can be made in the same manner. The sound proofing layer 12 and the honeycomb layer 14 can be made of composite material.

The reflecting layer 16 is made of composite material. It comprises at least two fiber layers 18, 18′ oriented parallel to the plane of the panel and embedded in a resin matrix. According to one embodiment, the reflecting layer 16 comprises at least two fiber layers 18, 18′ which can either be woven or not, and can be pre-impregnated with resin or not, with the layers draped over each other. The wall can include more than two layers of fibers. By themselves, these fibers break when subjected to bending forces. According to the invention, the fibers are carbon fibers. As an example, to give an idea of the dimensions, the carbon fibers have a diameter between 0.005 mm and 0.015 mm or a section smaller than 0.0002 mm².

According to the present invention, the wall 16 comprises a reinforcement mesh 20 inserted between two fiber layers 18, 18′ and embedded in the resin matrix. This reinforcement mesh 20 comprises at least one first series of linear elements 22 oriented at least in one direction. According to an important point of the invention, this reinforcement mesh 20 is sandwiched between two fiber layers and is embedded in the resin matrix, so that the two layers 18, 18′ located on each side are connected in all zones situated between the linear elements 22. This arrangement of the fiber layers and reinforcement mesh confers to the wall improved resistance against bending. In case of an incident, even if the stresses provoke the breakage of the wall fibers, the linear elements 22 prevent the dislocation of the wall while limiting damage to the wall and preserving its structure.

According to the invention, the carbon fibers 18,18′ represent the main force path while the linear elements 22 reinforce the mechanical characteristics of the assembly by giving improved resistance against bending to the wall obtained in this manner.

Advantageously, the matrix in which the fiber layers and the reinforcement mesh are embedded is continuous on both sides of the reinforcement mesh 20 and is polymerized during the same polymerization phase. In this way, the wall is not consisting of two distinct matrices on each side of the reinforcement mesh plane, assembled together at said plane of the reinforcement mesh.

The orientation of the linear elements is selected according to the most likely direction of the cracks. By preference, the linear elements 22, 22′ are made in one piece and have a section greater than or equal to 0.07 mm², which in case of a circular section corresponds with a diameter greater than or equal to 0.3 mm. In order to obtain a significant improvement of the wall characteristics, the linear elements 22, 22′ have a section greater than or equal to 0.38 mm², which in case of a circular section corresponds with a diameter greater than or equal to 0.7 mm. By preference, the linear elements have a thickness smaller than or equal to 1mm.

Advantageously, the adjacent linear elements of the same series are regularly spaced. The linear elements can have the same spacing from one series to another. By preference, the spacing between two linear elements is greater than or equal to 10 times the dimension (measured in the same plane as the spacing) of the linear element.

Advantageously, the reinforcement mesh 20 comprises two or more series of linear elements 22, 22′ with different orientations from one series to another. According to the example illustrated in FIGS. 2 and 3, the reinforcement mesh 20 comprises linear elements 22 oriented according to a first direction and linear elements 22′ oriented according to a second direction perpendicular to the first direction.

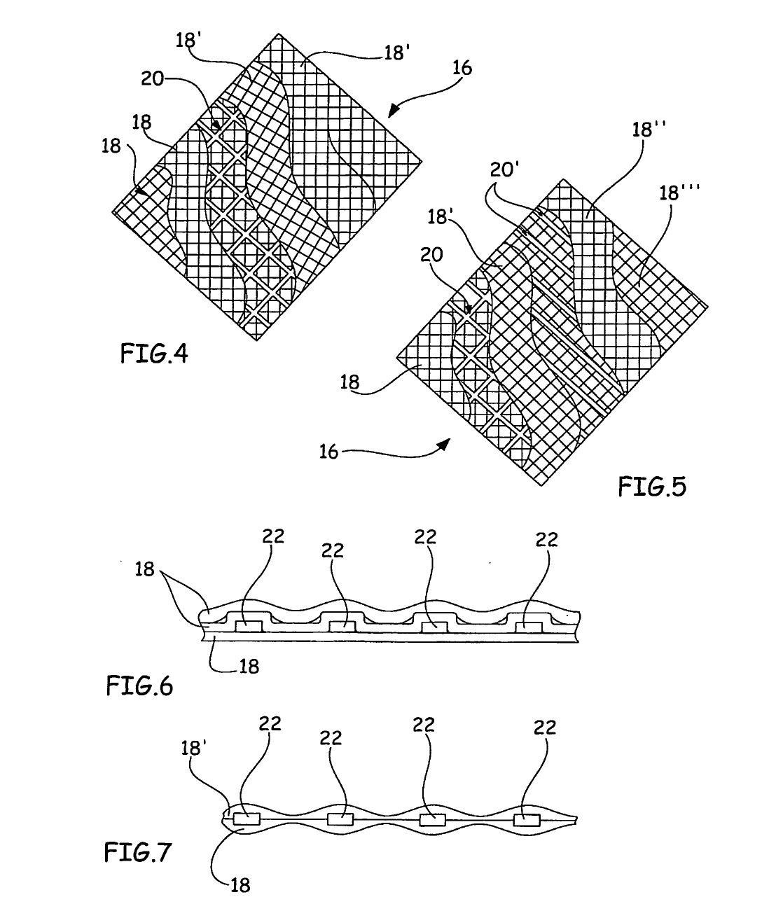

According to an embodiment illustrated in FIG. 3, the continuous, linear elements 22, 22′ are distinct one from the other. In this case, the reinforcement mesh 20 is in the form of a trellis or a wire netting. According to another embodiment illustrated in FIG. 4, the linear elements 22, 22′ can originate from one or more juxtaposed bands, each band comprising at least two continuous linear elements 20 according to a first direction linked by a plurality of linear elements 20′ perpendicular to elements 20.

As shown in FIG. 3, each band is in the form of a plate 24 in which cutouts 26 have been made defining a linear element between two adjacent cutouts 26. According to one embodiment, these cutouts are square and spaced at a distance corresponding with the dimensions of the linear elements.

With respect to implementation, the reinforcement mesh 20 can be provided between two fiber layers, which results from the juxtaposition of several reinforcement meshes. When several reinforcement meshes are juxtaposed, it is preferable to avoid overlap of reinforcement meshes in the juxtaposition zones. The fact that a mesh is provided in the form of bands with openings avoids the risk of overlap.

According to another advantage, the fact that a reinforcement mesh 20 is provided in the form of bands with openings makes it possible to limit the thickness of the mesh. In the case of one band, it is possible to combine a thickness of 0.5 mm with linear elements 22, 22′ of 0.7 mm width in the plane of the reinforcement mesh 20, which corresponds with a section of 0.35 mm². To obtain the same section, the linear elements of a reinforcement mesh in the form of a wire netting must have a diameter of 0.65 mm, which in the specific locations where the linear elements cross, corresponds with a point to point thickness of 1.3 mm The fact that a reinforcement mesh is provided without excessive point to point thickness reduces the risk of breaking the fibers of the adjacent layers.

According to a preferred embodiment, the reinforcement mesh consists of a band with two linear elements with a thickness of 0.4 mm², a width of 3 mm, equal to a section of 1.2 mm². According to variants, the wall 16 can comprise a single reinforcement mesh (or several juxtaposed meshes) between two fiber layers as illustrated in FIG. 4. According to the embodiment illustrated in FIG. 4, the wall 16 comprises two fiber layers 18, a reinforcement mesh 20 and two fiber layers 18′.

According to other variants, the wall 16 can comprise several meshes (each of which can comprise several juxtaposed reinforcement meshes), whereby each is inserted between two fiber layers, as illustrated in FIG. 5. These reinforcement layers can be identical or different as illustrated in FIG. 5, where a first reinforcement layer 20 has the form of bands with juxtaposed openings, and the other mesh has the form of linear elements arranged in one direction. According to the implementation mode illustrated in FIG. 5, the wall 16 comprises a fiber layer 18, a reinforcement mesh 20, a fiber layer 18′, a reinforcement layer 20′ and two fiber layers 18″ and 18″'.

According to variants, the linear elements 22, 22′ can have a round section or a polygonal section, in particular square or rectangular. The reinforcement mesh is by preference metallic. However, when the reinforcement mesh comprises distinct linear elements, oriented according to at least one direction, aramid linear elements can be used. In this case, the linear elements are coated as illustrated in FIG. 8. Depending on the material used for the reinforcement mesh and the matrix, the reinforcement mesh 20 can comprise a coating 28, for instance in polytetrafluoroethylene, which isolates the linear elements 22, 22′ from the matrix and allows for a slight movement of said linear elements 22, 22′ relative to said matrix.

Depending on the case, the linear elements 22 of the reinforcement mesh 20 can be embedded in a single adjacent layer 18′, as illustrated in FIG. 6, or partially embedded in the two adjacent layers 18, 18′ as illustrated in FIG. 7.

Although applied to the reflecting wall of an acoustic panel, the invention can be applied to all walls in composite material. When the wall 16 is used as reflective wall of an acoustic panel of an air inlet, said wall 16 is protected by the porous sound proofing layer 12 and at least one honeycomb structure 14, so that the risk is limited of cutting the reinforcement mesh by sharp debris originating for instance from the breakage of a fan blade.

1. A wall panel of composite material comprising:
at least two carbon fiber layers oriented parallel to the plane of the panel and embedded in a resin matrix;
at least one reinforcement mesh inserted between said two fiber layers, said mesh comprising at least one first series of linear elements each element having a section greater than or equal to 0.07 mm², wherein said reinforcement mesh is embedded in the resin matrix, and the two carbon fiber layers are connected in all zones situated between the linear elements.

2. The wall panel of composite material according to claim 1, wherein the linear elements have a section greater than or equal to 0.38 mm².

3. The wall panel of composite material according to claim 1, wherein the spacing between the linear elements is greater than or equal to 10 times the dimension of a linear element.

4. The wall panel of composite material according to claim 1, wherein the linear elements of a reinforcement mesh have a thickness smaller than or equal to 1 mm.

5. The wall panel of composite material according to claim 1, wherein the continuous linear elements of a reinforcement mesh are distinct one from the others.

6. The wall panel of composite material according to claim 1, wherein the reinforcement mesh comprises one or more juxtaposed bands having at least two continuous linear elements according to a first direction linked by a plurality of linear elements.

7. The wall panel of composite material according to claim 6, wherein each band comprises a plurality of cutouts defining a linear element between two adjacent cutouts.

8. The wall panel of composite material according to claim 1, wherein the reinforcement mesh comprises a coating which isolates the linear elements.

9. The wall panel of composite material according to claim 8, wherein the coating is polytetrafluoroethylene.

10. A wall panel for acoustic treatment of an aircraft comprising a reflecting wall according to claim 1.
